(19) United States
(12) Patent Application Publication
(10) Pub. No.: US 2023/0094675 A1
(43) Pub. Date: Mar. 30, 2023

(54) DIGITAL TWIN BASED MANAGEMENT OF ELECTRONIC WASTE

(71) Applicant: International Business Machines Corporation, Armonk, NY (US)

(72) Inventors: Saraswathi Sailaja Perumalla, Visakhapatnam (IN); Venkata Vara Prasad Karri, Visakhapatnam (IN); Amit Kumar Senapaty, Visakhapatnam (IN); Shikhar Kwatra, San Jose, CA (US); Sarbajit K. Rakshit, Kolkata (IN)

(21) Appl. No.: 17/488,870

(22) Filed: Sep. 29, 2021

(51) Int. Cl. G06Q 30/00; G06Q 10/00; G06T 17/05; G06T 19/00

(52) U.S. Cl. CPC G06Q 30/018; G06Q 10/30; G06T 17/05; G06T 19/006

(57) ABSTRACT

A processor may receive an information dataset. The information dataset may include geographical area information and electronic waste information. A processor may generate a digital twin of the physical geographical area. The digital twin may be based, at least in part, on the information dataset. A processor may simulate one or more factors on the physical geographical area. A processor may predict, responsive to simulating the one or more factors, one or more electronic waste impacts on the physical geographical area.

### BACKGROUND

The present disclosure relates generally to the field of waste management, and more particularly to the field of electronic waste management.

Growth in the technology and communication industries has resulted in a significant increase in the electronics people use on a daily basis. Unfortunately, such growth has also resulted in the reciprocal increase of electronic waste. Electronic waste often includes toxic components that, if not properly disposed of, can result in damage to the surrounding environment and inhabitants.

### SUMMARY

Embodiments of the present disclosure include a method, computer program product, and system for managing electronic waste in a geographical area. A processor may receive an information dataset. The information dataset may include geographical area information and electronic waste information. A processor may generate a digital twin of the physical geographical area. The digital twin may be based, at least in part, on the information dataset. A processor may simulate one or more factors on the physical geographical area. A processor may predict, responsive to simulating the one or more factors, one or more electronic waste impacts on the physical geographical area.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a block diagram of an embodiment of an electronic waste management system, in accordance with the present disclosure.

FIG. 2 illustrates a flowchart of a method for managing electronic waste, in accordance with embodiments of the present disclosure.

FIG. 3A illustrates a cloud computing environment, in accordance with embodiments of the present disclosure.

FIG. 3B illustrates abstraction model layers, in accordance with embodiments of the present disclosure.

FIG. 4 illustrates a high-level block diagram of an example computer system that may be used in implementing one or more of the methods, tools, and modules, and any related functions, described herein, in accordance with embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

The present disclosure relates generally to the field of digital twin technology, and more particularly to the field of generating simulations using digital twins, such as those related to electronic waste management. While the present disclosure is not necessarily limited to such applications, various aspects of the disclosure may be appreciated through a discussion of several examples using this context.

The growth in technology over the past decade has resulted in the widespread use of electronic equipment by people, both in their personal and professional lives. The continuous renovation or updates, and introduction of new electronic products has resulted in consumers replacing electronic products (e.g., mobile cellphones, laptops, tablets, etc.) with newer editions. While new electronic products often provide additional services, old devices are often considered obsolete and discarded or disposed of. This cycle of replacing electronic devices has resulted in the increase of electronic waste and pollution to environment caused by improper disposal of the electronic waste. As such, there is a desire to ensure that electronic waste is properly managed to prevent harm to the environment and those organisms inhabiting the environment.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

It will be readily understood that the instant components, as generally described and illustrated in the Figures herein, may be arranged and designed in a wide variety of different configurations. Accordingly, the following detailed description of the embodiments of at least one of a method, apparatus, non-transitory computer readable medium and system, as represented in the attached Figures, is not intended to limit the scope of the application as claimed but is merely representative of selected embodiments.

The instant features, structures, or characteristics as described throughout this specification may be combined or removed in any suitable manner in one or more embodiments. For example, the usage of the phrases “example embodiments,” “some embodiments,” or other similar language, throughout this specification refers to the fact that a particular feature, structure, or characteristic described in connection with the embodiment may be included in at least one embodiment. Accordingly, appearances of the phrases “example embodiments,” “in some embodiments,” “in other embodiments,” or other similar language, throughout this specification do not necessarily all refer to the same group of embodiments, and the described features, structures, or characteristics may be combined or removed in any suitable manner in one or more embodiments. Further, in the FIGS., any connection between elements can permit one-way and/or two-way communication even if the depicted connection is a one-way or two-way arrow.

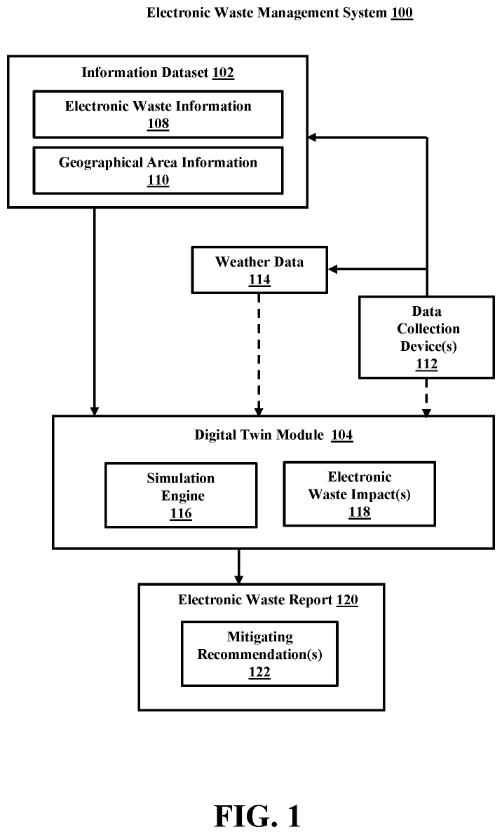

Also, any device depicted in the drawings can be a different device. For example, if a mobile device is shown sending information, a wired device could also be used to send the information. The term “module” may refer to a hardware module, software module, or a module may be a combination of hardware and software resources. Embodiments of hardware-based modules may include self-contained components such as chipsets, specialized circuitry, one or more memory devices and/or persistent storage. A software-based module may be part of a program, program code or linked to program code containing specifically programmed instructions loaded into a memory device or persistent storage device of one or more data processing systems operating as part of the computing environment (e.g., intelligent ecosystem 100). For example, data associated with action module 104, depicted in FIG. 1, can be loaded into memory or a database.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application and to enable others of ordinary skill in the art to understand the disclosure for various embodiments with various modifications as are suited to the particular use contemplated.

In embodiments discussed herein, solutions are provided in the form of a method, system, and computer program product, for managing electric wasted based on digital twin technology. In embodiments, a processor may be configured to utilize artificial intelligence enabled digital twin technology to manage electronic waste in a particular physical geographical area. As the demand for electronics has increased, so too has the resulting electronic waste. Electronic waste is not only generated by users discarding outdated or damaged electronics, but also by distribution and manufacturing facilities who produce electronic products.

While electronic waste is known to include a variety of toxic substances such as, lithium, mercury, arsenic, cadmium, and polychlorinated biphenyls (PCBs), electronic waste also includes valuable metals (e.g., gold, copper, silver, and platinum) and materials that may be recycled. As such, it is imperative that electronic waste is properly disposed of. While losing possibly valuable or reusable resources (e.g., copper and gold) may be wasteful, the release of toxic substances into the environment can result in harm to organisms living in the environment. In many situations, different weather patterns can result in the toxic substances being transported from the immediate area to more sensitive environments such as, farmlands and other protected lands. Often, different regions (e.g., geographical areas) provide no practical guidance regarding how users and businesses can properly dispose of electronic waste. Accordingly, embodiments contemplated herein provide solutions for managing such electronic waste to mitigate harm associated with the pollution resulting from toxic substances and increase the components of electronic waste that may be reused or reclaimed (e.g., valuable metals).

In embodiments, a processor may be configured to manage electronic waste using augmented intelligence and/or artificial intelligence (AI) enabled digital twin technology. In these embodiments, the processor may be configured to receive or collect an information dataset associated with a particular geographical area. The processor may then use the information dataset to generate the digital twin of the geographical area. A geographical area may include, but is not limited to, any area such as, a region (e.g., Southern California), county, city/town (e.g., Baltimore, Farmersville), a particular zone within a city/town (e.g., industrial zones, school zones, hospital zones etc.), apartment complex, building, or any combination thereof. The information dataset may include geographical area information and electronic waste information. Geographical area information may include information associated with the geographical area (e.g., physical geographical area) that may be required to generate a digital twin of the geographical area.

More particularly, geographical area information may include, but is not limited to, the layout of geographical area, such the boundaries of the geographical area, configuration of the land (e.g., bodies of water, mountainous terrain, movement of underground water, etc.), land composition (e.g., concentration and materials found in the ground water, concentration and materials found in the soil), waterpipe systems (e.g., septic and drinking water systems), buildings and other manmade structures (e.g., roads, reservoirs, etc.), traffic patterns (associated with the movement of vehicles and/or people), and weather patterns (e.g., those associated with the particular geographical area). In one embodiment, a processor may receive geographical area information (e.g., via one or more data collection devices) that includes metadata attributes or properties of the geographical area. The processor may use this geographical area information to generate a grid map or geofence of an area within the boundaries of the geographical area that may be useful when generating the digital twin of the geographical area.

In embodiments, a processor may identify electronic waste as any product or portion of a product having one or more electronic components, such as electrical circuits or batteries, that are no longer wanted or intended to be used. Electronic waste information may include, but is not limited to, the location of electronic waste within the geographical area, the amount of electrical waste at a particular location, the different types of electronic waste at a particular location, the properties of electronic waste identified (e.g., the potential of reactivity, toxicity level, etc.), health and safety data sheets associated with different chemicals and components that may be found in electronic waste (e.g., accessed from a database or historical repository), historical data associated with electrical waste in the geographical area collected over time, and data associated with the movement and concentrations of electronic waste within the geographical area.

In embodiments, a processor may collect/receive the geographical area information and/or electronic waste information (e.g., information dataset) using one or more data collection devices. Data collection devices may include, but are not limited to, one or more sensors (e.g., LIDAR (light detection and ranging) sensors and turbidity sensors), IoT (Internet of Things) devices, (e.g., olfactory and chemical detecting devices), weather satellites, recording systems configured to capture environmental parameters (e.g., real-time weather patterns), or other smart devices (e.g., smart cameras, smart bins, digital devices, smart poles, etc.) configured with the geographical area. One or more data collection devices may be connected or coupled to one or more components (e.g., buildings, telephone poles, streetlights, public transportation, etc.) within the geographical area. In some embodiments, a processor may configure the data collection devices may be interconnected over a network to share data/information (e.g., geographical area information and/or electronic waste information).

For example, a processor may be configured to receive electronic waste information from a data collection device attached to a telephone pole located on the street corner of a busy intersection. In this example, the processor may collect electronic waste information associated with the type and amount of electronic waste located on the street. While in some embodiments, a processor may only receive geographical area information from a particular data collection device and electronic waste from a different, separately configured data collection device, in other embodiments, a process may configure the data collection device to collect both geographical area information and electronic waste information. For example, a processor could be configured to continuously receive information from a data collection device configured on a public transportation bus. In this embodiment, the data collection device could collect geographical area information associated with the concentrations and movement of people and vehicles as well as, electronic waste information associated with identifying electronic waste within the geographical area.

In one example embodiment, a processor may receive information associated with information dataset from a sensor configured to survey the geographical area. The sensor may be configured with one or more data collection devices, such as an LIDAR sensor and/or a smart camera. In this embodiment, using the LIDAR sensor, a sensor may be directed to collect electronic waste information and/or geographical area information throughout the geographical area. For example, data collected from the LIDAR sensor may collect data and estimate electronic waste concentrations and amounts by generating hyper-localization mapping and scatternet networks (e.g., using LSTM (long short term memory) models that consider the historical patterns at particular locations within the geographical area).

In some embodiments, a processor may use the information dataset (e.g., information collected from the LIDAR sensor) to perform an VSLAM (Visual Simultaneous Localization and Mapping) algorithm. In these embodiments, a processor may access the geographical area information (e.g., weather API and electric waste information collected from one or more data collection devices) to generate location wise clustering and mapping of the geographical area. For example, using a VSLAM algorithm, a processor can produce 3D mapping with a geofence X-Y coordinate location. In some embodiments, one or more sensors may be deployed (e.g., using the VSLAM algorithm) to map high density areas within the geographical area. In some embodiments, a processor may configure the sensor to compute to estimate the electronic waste consumption, based on the mapped coordinates and/or electronic waste information received from one or more data collection devices. In one example embodiment, a processor may receive information from a smart pole and a sensor associated with a particular location within the geographical area. The smart pole and the sensor may collect information in concert (e.g., electronic waste information and/or geographical area information) and may store such information in the historical repository.

In embodiments, a processor may continuously receive data associated with geographical area information and electronic waste information. A processor may store this information in an historical repository. In some embodiments, a processor may store one or more other types of historical data in the historical repository. For example, a processor may be configured to store historical data such as, medical journals (e.g., those pertaining to toxic substances found in electronic waste), electronic waste regulations (e.g., country policies), dictionaries of chemicals and/or ailments associated with electronic waste and/or pollution caused by electronic waste, and historical corpus (e.g., generated from multiple data collection devices). A processor may use historical data, to generate and use a historical corpus to determine high and low risk levels in an existing ecosystem to identify or predict (e.g., using digital twin) high and low risk levels within the particular geographical area and mitigating the risk. This data may be accessed by the processor at a later time to generate or update the digital twin and/or perform one or more particular simulations associated with the geographical area (e.g., using the digital twin).

In embodiments, a processor may use augmented intelligence and AI capabilities to generate a digital twin of the geographical area (e.g., physical geographical area). The digital twin may be configured using geographical area information and electronic waste information collected/received in real-time (e.g., using aforementioned mapping techniques) as well as historical data stored in the historical repository from one or more data collection devices. In embodiments, the digital twin may be configured to function in the same or similar fashion as the actual physical geographical area would be expected to perform under similar circumstances. In embodiments a processor may use the digital twin to simulate one or more factors associated with the geographical area. A factor may be any consideration or aspect of geographical area that may be of interest to a user. For example, a factor may include, but is not limited to, changes to electronic waste disposal policies and their effect on the geographical area, particular weather patterns, vulnerability of particular locations (e.g., farmlands and other protected locations/environments), and weather patterns. In some embodiments, a processor may be configured to perform an LSTM (long short-term memory) algorithm. In these embodiments, a processor may use an LSTM algorithm for regression with time steps for multi-variate forecasting. This may be used as part of the electronic waste simulation or predictor.

In some embodiments, a processor may be configured by a user to consider specific weather patterns and their effect on the electronic waste distributed through the geographical area. While in some embodiments, a processor may be configured to access weather pattern information associated with the geographical area from a third party weather provider, in other embodiments, a processor may use AI and machine learning techniques to analyze historical geographical area information (e.g., historical weather API data points) from the historical repository and collected from one or more data collection devices over time. In these embodiments, a processor may use this historical geographical area information to determine different aspects of the weather pattern (e.g., rain, cyclone, temperature, wind speeds, wind direction, pressure etc.) and their effect on different components (e.g., drinking water, sewage system, farmlands, etc.) of the geographical area.

In some embodiments, a processor may configure a digital twin of a geographical area (e.g., physical geographical area) demonstrating the different types of electronic waste, amounts of electronic waste, and the location of each electronic waste currently occupying a geographical area. The simulations of one or more factors (e.g., different weather patterns) on the digital twin may be used to predict one or more electronic waste impacts on the geographical area. Electronic waste impacts, or impacts, area a prediction, based on the simulation of the digital twin, how electronic waste may change as a result of applying one or more factors to the digital twin, and how those changes may impact the geographical area and/or different portions of the geographical area. In some embodiments, this information may be summarized as a risk level. For example, if one or more factors results in a piece of electronic waste located within a localized portion of the geographical area to produce a gas, a processor may determine or predict one or more electrical waste impacts, such as if the gas is toxic, and whether the gas will affect a localized portion of the geographical area or the entirety of the geographical area. A processor may assign a higher or elevated risk level to simulations or situations where the simulation predicts electronic waste impacts that negatively affect or harm the geographical area in some way. For example, caustic chemicals may negatively affect structures or buildings within the geographical area as well as potentially harm living organisms.

In these embodiments, a processor may be configured by a user to simulate how different weather patterns (e.g., one or more factors) impact the electronic waste and the geographical area. In these embodiments, a processor could simulate a variety of weather patterns, based on historical weather data analyzed by AI and machine learning capabilities. In such embodiments, a processor may determine if there is a change in risk level based on different weather patterns. In one example embodiment, A processor may simulate how the electronic waste and geographical area are affected by heavy rain fall and freezing temperatures. In these embodiments, a processor may identify and categorize each electronic waste component within the geographical area using the information dataset. The processor may then simulate freezing temperatures (e.g., one or more factors) using AI and machine learning capabilities to analyze the information dataset. The processor may identify if there are any changes (e.g., impacts) to the electronic waste or the geographical area resulting from the freezing temperatures. In this example embodiment, a processor may determine that there is no change in risk level if simulating freezing temperatures did not result in changes to the electrical waste.

In embodiments, where a processor simulates rain or heavy rain on the digital twin, a processor may determine if the rainwater results in in movement of the electronic waste (e.g., floating through a drainage system) to another location, if the rainwater results in chemicals from the electronic waste leaching into the surrounding soil, ground water, or being transported through the drainage system. In some embodiments, a processor may predict how the particular chemicals associated with the electronic waste may affect the soil and/or ground water (e.g., will the chemicals affect vegetation and organisms who encounter or inhabit the contaminated soil/ground water (e.g., whether the chemicals are toxic or benign to humans or the environment).

In embodiments where a processor determines that the chemicals from the electrical waste have leached into the water system and are transported with the rainwater, a processor may determine the likelihood of a chemical reaction occurring with the chemicals associated with the electrical waste and another chemical, such as a chemical form a different electrical waste or other source (e.g., pesticide or fertilizer runoff). In these embodiments, a processor may identify the two components and determine if the resulting reaction from the combination of components would form a new/different liquid/gas/particulate that may have additional toxic properties that may pollute the environment and harm those organisms occupying the environment. In such embodiments, a processor may access other historical information, such as medical journals, to determine which substances or chemicals may result in moderate to severe health concerns. In some embodiments, a processor may simulate and estimate effluent waste, particularly associated with industries and/or facilities known to produce electronic waste having using toxic components.

In some embodiments, a processor may identify vulnerable areas, such as farmlands school zones, or protected environments. In these embodiments, a user may configure the processor to determine if a particular weather pattern or if over time, the electrical waste may result in harming or contribute to harming vulnerable areas. For example, if a processor simulates a rainstorm and determines toxic electrical waste or effluent electrical waste (e.g., associated with electrical waste manufacturing) is washed into a stream during a rainstorm, the processor may simulate and determine that stream is polluted (e.g., electrical waste impact). The processor may then simulate how the polluted stream may affect surrounding lands. For example, a processor may determine that the polluted stream is used to irrigate large farmlands and feeds into a ground water system. In this example, the processor could estimate the chemicals and the concentrations of the pollutants in the polluted stream to predict their effect on the farmlands (e.g., will the vegetation grown on the farmlands be negatively impacted). In such embodiments, the processor may determine there is a higher or elevated risk associated with the position of the electrical waste within the geographical area if it were to rain heavily within the geographical area.

In embodiments, a processor may generate an electronic waste report. The electronic waste report may include one or more electronic waste impacts, based at least in part on the digital twin of the geographical area. While in some embodiments, a processor may be configured by a user to include all of the electronic waste impacts predicted or considered during digital twin simulation in the electronic waste report, in other embodiments, a processor may be configured to only include those electronic waste impacts that have a higher or elevated risk level. An electronic waste report may what factors may increase the risk level associated with the electrical waste. For example, if the electrical waste includes chemicals that may be influenced by heat, rain, or combining with other chemicals from the surrounding environment. In some embodiments, a processor may identify a dynamic safe zone. The dynamic safe zone may be included in the electrical waste report. Safe zones may be free of pollutants and/or may include tools that may be used to manage electronic waste. In some embodiments, the electronic waste report may be provided in the form of an interactive map. In these embodiments, the electronic waste report may allow users to select particular locations or portions of the geographical area to receive information on. The user may toggle through different locations within the geographical area and view the information associated with electrical waste report specific to each area.

In some embodiments, the processor may generate one or more mitigating recommendations associated with one or more of the predicted electronic waste impacts. These mitigating recommendations may be included in the electronic waste report. A mitigating recommendation may have one or more steps that may eliminate or reduce the predicted impact of the electronic waste impact. The mitigating recommendation may include, but is not limited to, scheduling timely preventative maintenance activities (e.g., like the frequency of clean-up or proactive maintenance), suggesting activates and/or policies (e.g., legislative policies or technology updates) associated with how electrical waste is managed in the geographical area, and identify if an item of electrical waste may be recycled, reused, or repurposed. For example, a user may want to dispose of useable lightbulbs. In this example, a processor could determine the lightbulbs can be reused and identify another user or charitable or commercial organization may be interested in procuring the lightbulbs. In some embodiments, a user may be able to access the electronic waste report using a portal (e.g., accessed via a tablet, laptop, mobile phone). In some embodiments, where a processor determines there is a high or elevated risk level, a processor may issue a notification to users who may be in the particular portion of geographical area that has the elevated risk and/or issue a notification to authorities associated with the geographical area. The authorities may then issue one or more corrective or mitigating actions based on the electrical waste report to ameliorate or eliminate the potential negative consequences associated with the electrical waste.

In some embodiments, a mitigating recommendation may include a change in policies or regulations associated with how waste or electronic waste is managed within the geographical area. For example, an electronic waste report may indicate that effluent electronic waste associated with a particular industry is harming farmlands when heavy rain causes the electronic waste to leach into the farmlands. In this example, the mitigating recommendation may recommend a treatment plan or may recommend policy changes regarding how facilities producing effluent electronic waste operate (e.g., facilities must ensure prevent effluent electronic waste or receive a monetary fine). In another example, a mitigating recommendation may recommend that the geographical area perform electronic waste collection once a month or week (e.g., depending on amount and/or type of electronic waste) to prevent related toxic substances from causing harm.

In some embodiments, a processor may receive the electronic waste report with one or more mitigating recommendation and automatically issue one or more instructions or notifications associated with one or more mitigating recommendations. For example, if a processor determines a smart bin is full of electronic waste, a processor may issue a notification to a waste disposal worker that the electronic waste should be collected on their next waste collection route. In these embodiments, a processor may configure the notification to include alerts or precautions regarding how the electrical waste should be properly disposed of. For example, the waste disposal worker may receive a notification that the smart bin should be emptied as well as guidelines or suggested kits/tools (e.g., face mask or gloves) that may be required for the worker to properly disposal of each particular electrical waste while also ensuring the worker's health is not harmed. In another example, a processor may generate a notification to each user within a particular portion of the geographical area if there is a toxic substance resulting from the electronic waste in the vicinity. Such toxic substances may result from chemical reactions caused by mixing components associated with electrical waste. In this example, if such substances are detected, a processor may generate an alert notification to each user within the particular portion (e.g., office building) and notify them of the possible danger and/or indicate how each user may evacuate to a safe portion of the geographical area.

In some embodiments, a processor may be configured to provide verbal instructions to a user. For example, a processor may be configured to provide verbal instructions associated with the electrical waste report, through an application in a mobile phone and/or an AI enabled assistance devices (e.g., Google Home®, Amazon Alexa®, Siri®, Bixby®, etc.). In some embodiments, a processor may provide a user with information (e.g., via an AI enabled assistance device) to indicate how a particular component of electronic waste can be properly managed (e.g., mitigating recommendation). For example, a user could point (e.g., detected using one or more data collection devices) to the particular component of electrical waste and inform the user of how and where the particular component may be properly disposed of, recycled, or reused.

In embodiments, a processor may access the historical repository and use historical information datasets to generate educational material. This educational material may include, but is not limited to, videos instructing users on proper disposal of electronic waste, lessons associated with electronic waste and its effects on the geographical area, lessons associated with instructing users (e.g., public health workers and community) how pollution caused by electronic can be mitigated, and how electronic waste improperly managed can impact the user. In some embodiments, a processor may distribute or broadcast the educational material to a variety of different mediums, such as social media or to a particular television station, that may be observed by users.

In an example embodiment, User A may be an administrator of the particular geographical area or a public health team and User B may be a citizen or residential complex. In this example embodiment, User B may have generated a variety of electronic waste (e.g., personal laptops, batteries, chargers, dryers, lights, capacitors, air conditioning components, etc.) that is disposed of in smart bins and traditional garbage bins. In embodiments, a processor may receive geographical area information and electrical waste information (e.g., information dataset) from data collection devices configured within the smart bin and data collection devices (e.g., IoT devices proximate to the traditional garbage bin) indicating that both the smart bin and the traditional garbage bin are both full of electrical waste. In embodiments, a processor may configure one or more data collection devices configured within the smart bin (e.g., IoT devices) and one or more data collections configured proximate to the traditional garbage bin (e.g., olfactory sensors and/or chemical sensors) to analyze the material in each bin and collect electronic waste information. In this example embodiment, User A may access (e.g., login using username and password or other opt-in mechanism) the electronic waste report generated by the using AI enabled digital twin technology using an application on a personal device (e.g., mobile phone, laptop, or tablet).

In some embodiments, User A may select a particular location within the geographical area, such as the location associated with User B or residential complex. After selecting the residential complex, User A may receive information associated with the electronic waste report indicating that the smart bin and the traditional garbage bin are full of electronic waste. In some embodiments, a processor may issue a notification to User A indicating that each bin is full and should be emptied to prevent the electrical waste from polluting the environment (e.g., one or more mitigating recommendations). In some embodiments, a processor may use AI and natural language processing techniques to generate understandings of users interacting with the electrical waste report (e.g., using IBM Watson® speech to text functions) who have opted-in. These generated understandings may be stored within the historical repository and may be accessed by the processor during analysis.

In another example embodiment, User A may be moving out of the geographical area to a new location. During the move, User A may identify items that they do not wish to take with them to the new location. For example, User A may determine they do not want to take, lightbulbs, batteries, or cables. In this embodiment, a processor may identify the items (e.g., electronic waste information) and determine if the items should be recycled, reused, or disposed of (e.g., electronic waste report). For example, a processor could determine and indicate in the electronic waste report, if the batteries still have sufficient charge (e.g., determined via data collection devices). In this example, a processor may recommend User A donate the batteries to a charity or to another user who wants the batteries (e.g., a mitigating recommendation). In some embodiments, the processor may be configured to enable users to post desired electronic items. For example, User A may post within an application configured by the processor that they have batteries available. Other users may view this post and may be collect the batteries from User A. In another example, a processor may indicate how the lightbulbs and cables may be correctly recycled and disposed of (e.g., disposing the lightbulbs and cables at a particular electronic waste disposal site).

In some embodiments, a processor may generate an interactive environment using the digital twin of the geographical area. The processor may generate the interactive environment using augmented reality (AR) and/or virtual reality (VR) techniques that enables a processor to display various aspects of the geographical area to a user. The interactive environment may allow the user to visually interact with digital twin simulation. In some embodiments, a user may interact with the interactive environment using an AR/VR headset. In embodiments, a processor may base the interactive environment, at least in part, on the one or more electronic waste impacts associated with the geographical area.

In one example embodiment, a processor may use the information dataset to configure a headset for User A and User B. Once each user has opted into the system (e.g., agreed to terms and conditions such as facial recognition), the processor may configure the headset to display the same or different interactive environments to each user. In this example embodiment, a processor may view the causes and effects associated with improperly disposing electronic waste, such as the electronic waste impacts associated with the particular geographical area. In this example, a processor may be configured to consider User A's and User B's reactions to the generated interactive environment. In embodiments, the processor may use the reactions of each user to curate and/or fine tune the interactive environment for further interactive environments. In some embodiments, a processor may access other historical data in the historical repository, such as country policies associated with the geographical area. In these embodiments, a processor may automatically curate the interactive environment using country policies or regulations and user reactions.

Referring now to FIG. 1, a block diagram of an electronic waste management system 100 for managing electronic waste, is depicted in accordance with embodiments of the present disclosure. FIG. 1 provides an illustration of only one implementation and does not imply any limitations with regard to the environments in which different embodiments may be implemented. Many modifications to the depicted environment may be made by those skilled in the art without departing from the scope of the invention as recited by the claims.

In embodiments, electronic waste management system 100 may include information dataset 102, digital twin module 104, and electronic waste report 106. In embodiments, electronic waste management system 100 may be configured to receive information dataset 102. Information dataset 102 may include electronic waste information 108 and geographical area information 110. In embodiments, electronic waste management system 100 may receive/collect information dataset 102 from a historical repository. In embodiments, data collection device(s) 112 may be configured to collect electronic waste information 108 and geographical area information 110 from the geographical area. In some embodiments, data collection device(s) 112 may be configured to collect weather data 114 associated with the geographical area. In some embodiments, weather data 114 may be considered geographical area information 110.

In embodiments, electronic waste management system 100 may be configured to generate a digital twin of the geographical area using digital twin module 104. In embodiments, digital twin module 104 may be configured to include simulation engine 116, and one or more electronic waste impacts 118. In embodiments, simulation engine 116 may use the digital twin of the geographical area and simulate one or more factors (e.g., how different weather patterns affect different electrical in the geographical area). In embodiments, electronic waste management system 100 may use simulation engine 116 to predict one or more electronic waste impacts 118 or how the one or more factors impacted the geographical area. In some embodiments, electronic waste impacts 118 may be incorporated in an electronic waste report 120. Electronic waste report 118 can be generated for users of electronic waste management system 100 and may provide the results associated with the simulations generated by digital twin module 104, such as how electronic waste impacts the geographical area. In some embodiments, electronic waste report 118 may include one or more mitigating recommendations 122. Mitigating recommendations 122 may include recommendations to reduce one or more electronic waste impacts 118 that may negatively effect and cause harm to the environment and/or inhabitants of the geographical area.

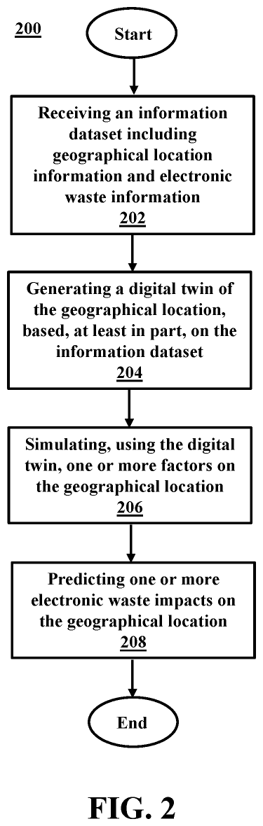

Referring now to FIG. 2, a flowchart illustrating an example method 200 for managing electronic waste, in accordance with embodiments of the present disclosure. FIG. 2 provides an illustration of only one implementation and does not imply any limitations with regard to the environments in which different embodiments may be implemented. Many modifications to the depicted environment may be made by those skilled in the art without departing from the scope of the invention as recited by the claims.

In some embodiments, the method 200 begins at operation 202 where the processor receives an information dataset. In embodiments, the information dataset may include geographical area information and electronic waste information. The method 200 proceeds to operation 204.

At operation 204, the processor generates a digital twin of the geographical area. In embodiments, the digital twin may be based, at least in part, on the information dataset. In some embodiments, the method 200 proceeds to operation 206.

At operation 206, the processor simulates, using the digital twin, one or more factors on the geographical area. In some embodiments, the method 200 proceeds to operation 208.

At operation 208, the processor predicts, responsive to simulating the one or more factors, one or more electronic waste impacts on the geographical area. In some embodiments, as depicted in FIG. 2, after operation 208, the method 200 may end.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of portion independence in that the consumer generally has no control or knowledge over the exact portion of the provided resources but may be able to specify portion at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

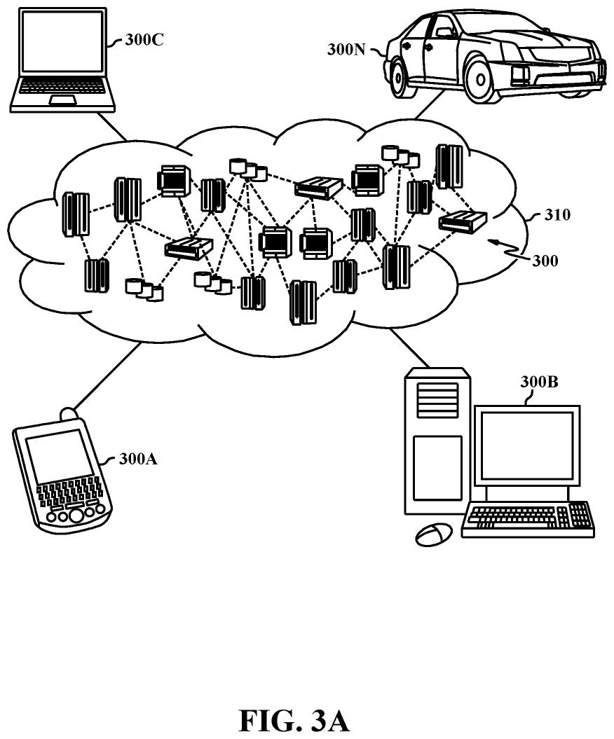

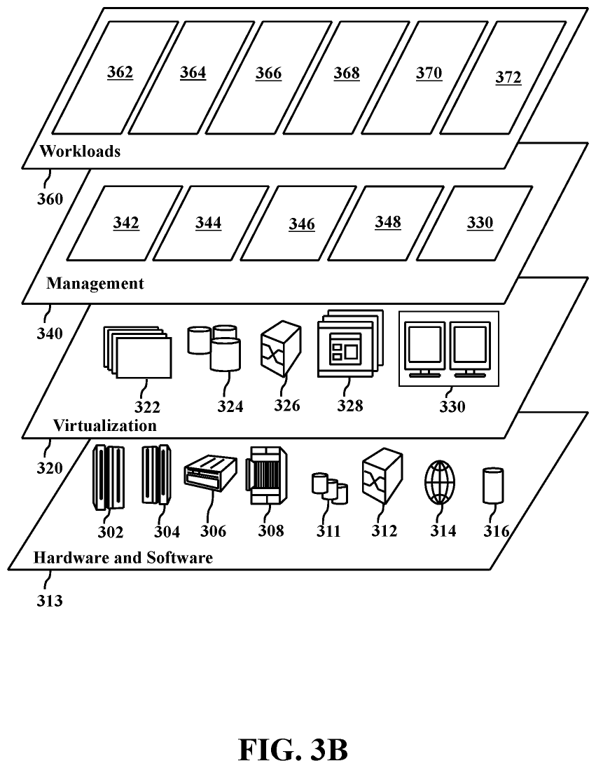

Referring now to FIG. 3A, illustrative cloud computing environment 310 is depicted. As shown, cloud computing environment 310 includes one or more cloud computing nodes 300 with which local computing devices used by cloud consumers, such as, for example, personal digital assistant (PDA) or cellular telephone 300A, desktop computer 300B, laptop computer 300C, and/or automobile computer system 300N may communicate. Nodes 300 may communicate with one another. They may be grouped (not shown) physically or virtually, in one or more networks, such as Private, Community, Public, or Hybrid clouds as described hereinabove, or a combination thereof. This allows cloud computing environment 310 to offer infrastructure, platforms and/or software as services for which a cloud consumer does not need to maintain resources on a local computing device. It is understood that the types of computing devices 300A-N shown in FIG. 3A are intended to be illustrative only and that computing nodes 300 and cloud computing 300 and cloud computing environment 310 can communicate with any type of computerized device over any type of network and/or network addressable connection (e.g., using a web browser).

Referring now to FIG. 3B, a set of functional abstraction layers provided by cloud computing environment 310 (FIG. 3A) is shown. It should be understood in advance that the components, layers, and functions shown in FIG. 3B are intended to be illustrative only and embodiments of the disclosure are not limited thereto. As depicted below, the following layers and corresponding functions are provided.

Hardware and software layer 315 includes hardware and software components. Examples of hardware components include: mainframes 302; RISC (Reduced Instruction Set Computer) architecture based servers 304; servers 306; blade servers 308; storage devices 311; and networks and networking components 312. In some embodiments, software components include network application server software 314 and database software 316.

Virtualization layer 320 provides an abstraction layer from which the following examples of virtual entities may be provided: virtual servers 322; virtual storage 324; virtual networks 326, including virtual private networks; virtual applications and operating systems 328; and virtual clients 330.

In one example, management layer 340 may provide the functions described below. Resource provisioning 342 provides dynamic procurement of computing resources and other resources that are utilized to perform tasks within the cloud computing environment. Metering and Pricing 344 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 346 provides access to the cloud computing environment for consumers and system administrators. Service level management 348 provides cloud computing resource allocation and management such that required service levels are met. Service Level Agreement (SLA) planning and fulfillment 350 provide pre-arrangement for, and procurement of, cloud computing resources for which a future requirement is anticipated in accordance with an SLA.

Workloads layer 360 provides examples of functionality for which the cloud computing environment may be utilized. Examples of workloads and functions which may be provided from this layer include: mapping and navigation 362; software development and lifecycle management 364; virtual classroom education delivery 366; data analytics processing 368; transaction processing 370; and managing electronic waste 372.

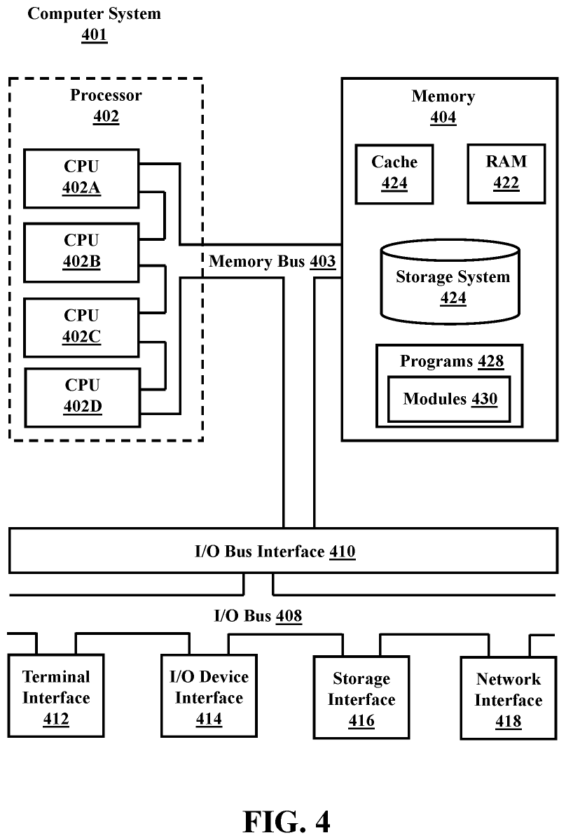

FIG. 4, illustrated is a high-level block diagram of an example computer system 401 that may be used in implementing one or more of the methods, tools, and modules, and any related functions, described herein (e.g., using one or more processor circuits or computer processors of the computer), in accordance with embodiments of the present invention. In some embodiments, the major components of the computer system 401 may comprise one or more Processor 402, a memory subsystem 404, a terminal interface 412, a storage interface 416, an I/O (Input/Output) device interface 414, and a network interface 418, all of which may be communicatively coupled, directly or indirectly, for inter-component communication via a memory bus 403, an I/O bus 408, and an I/O bus interface unit 410.

The computer system 401 may contain one or more general-purpose programmable central processing units (CPUs) 402A, 402B, 402C, and 402D, herein generically referred to as the CPU 402. In some embodiments, the computer system 401 may contain multiple processors typical of a relatively large system; however, in other embodiments the computer system 401 may alternatively be a single CPU system. Each CPU 402 may execute instructions stored in the memory subsystem 404 and may include one or more levels of on-board cache.

System memory 404 may include computer system readable media in the form of volatile memory, such as random access memory (RAM) 422 or cache memory 424. Computer system 401 may further include other removable/non-removable, volatile/non-volatile computer system storage media. By way of example only, storage system 426 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 404 can include flash memory, e.g., a flash memory stick drive or a flash drive. Memory devices can be connected to memory bus 403 by one or more data media interfaces. The memory 404 may include at least one program product having a set (e.g., at least one) of program modules that are configured to carry out the functions of various embodiments.

One or more programs/utilities 428, each having at least one set of program modules 430 may be stored in memory 404. The programs/utilities 428 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 428 and/or program modules 430 generally perform the functions or methodologies of various embodiments.

Although the memory bus 403 is shown in FIG. 4 as a single bus structure providing a direct communication path among the CPUs 402, the memory subsystem 404, and the I/O bus interface 410, the memory bus 403 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 410 and the I/O bus 408 are shown as single respective units, the computer system 401 may, in some embodiments, contain multiple I/O bus interface units 410, multiple I/O buses 408, or both. Further, while multiple I/O interface units are shown, which separate the I/O bus 408 from various communications paths running to the various I/O devices, in other embodiments some or all of the I/O devices may be connected directly to one or more system I/O buses.

In some embodiments, the computer system 401 may be a multi-user mainframe computer system, a single-user system, or a server computer or similar device that has little or no direct user interface, but receives requests from other computer systems (clients). Further, in some embodiments, the computer system 401 may be implemented as a desktop computer, portable computer, laptop or notebook computer, tablet computer, pocket computer, telephone, smartphone, network switches or routers, or any other appropriate type of electronic device.

It is noted that FIG. 4 is intended to depict the representative major components of an exemplary computer system 401. In some embodiments, however, individual components may have greater or lesser complexity than as represented in FIG. 4, components other than or in addition to those shown in FIG. 4 may be present, and the number, type, and configuration of such components may vary.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present invention has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

What is claimed is:

1. A method of managing electronic waste in a physical geographical area, the method comprising:
receiving, by a processor, an information dataset, wherein the information dataset includes geographical area information and electronic waste information;
generating a digital twin of a physical geographical area, wherein the digital twin of the physical geographical area is based, at least in part, on the information dataset;
simulating one or more factors on the digital twin of the physical geographical area; and
predicting, responsive to simulating the one or more factors, one or more electronic waste impacts on the physical geographical area.

2. The method of claim 1, wherein the information dataset is received from a real-time data feed associated with one or more data collection devices.

3. The method of claim 1, further comprising:
generating an interactive environment based, at least in part, on the one or more electronic waste impacts on the physical geographical area; and
displaying the interactive environment to a user.

4. The method of claim 1, wherein geographical area information includes weather data associated with the physical geographical area.

5. The method of claim 1, further comprising:
generating a risk level associated with the one or more electronic waste impacts; and
providing a notification to a user, wherein the notification includes the risk level.

6. The method of claim 1, further comprising:
generating an electronic waste report, wherein the electronic waste report includes the one or more electronic waste impacts; and
providing the electronic waste report to a user.

7. The method of claim 6, wherein the electronic waste report further includes:
generating one or more mitigating recommendations associated with the one or more electronic waste impacts.

8. A system for managing electronic waste in a physical geographical area, the system comprising:
a memory; and
a processor in communication with the memory, the processor being configured to perform operations comprising:
receiving an information dataset, wherein the information dataset includes geographical area information and electronic waste information;
generating a digital twin of a physical geographical area, wherein the digital twin of the physical geographical area is based, at least in part, on the information dataset;
simulating one or more factors on the digital twin of the physical geographical area; and
predicting, responsive to simulating the one or more factors, one or more electronic waste impacts on the physical geographical area.

9. The system of claim 8, wherein the information dataset is received from a real-time data feed associated with one or more data collection devices.

10. The system of claim 8, further comprising:
generating an interactive environment based, at least in part, on the one or more electronic waste impacts on the physical geographical area; and
displaying the interactive environment to a user.

11. The system of claim 8, wherein geographical area information includes weather data associated with the physical geographical area.

12. The system of claim 8, further comprising:
generating a risk level associated with the one or more electronic waste impacts; and
providing a notification to a user, wherein the notification includes the risk level.

13. The system of claim 8, further comprising:
generating an electronic waste report, wherein the electronic waste report includes the one or more electronic waste impacts; and
providing the electronic waste report to a user.

14. The system of claim 13, wherein the electronic waste report further includes:
generating one or more mitigating recommendations associated with the one or more electronic waste impacts.

15. A computer program product for managing electronic waste in a physical geographical area, the computer program product comprising a computer readable storage medium having program instructions embodied therewith, the program instructions executable by a processor to cause the processors to perform a function, the function comprising:
receiving an information dataset, wherein the information dataset includes geographical area information and electronic waste information;
generating a digital twin of a physical geographical area, wherein the digital twin of the physical geographical area is based, at least in part, on the information dataset;
simulating one or more factors on the digital twin of the physical geographical area; and
predicting, responsive to simulating the one or more factors, one or more electronic waste impacts on the physical geographical area.

16. The computer program product of claim 15, wherein the information dataset is received from a real-time data feed associated with one or more data collection devices.

17. The computer program product of claim 15, further comprising:
generating an interactive environment based, at least in part, on the one or more electronic waste impacts on the physical geographical area; and
displaying the interactive environment to a user.

18. The computer program product of claim 15, wherein geographical area information includes weather data associated with the physical geographical area.

19. The computer program product of claim 15, further comprising:
generating a risk level associated with the one or more electronic waste impacts; and
providing a notification to a user, wherein the notification includes the risk level.

20. The computer program product of claim 15, further comprising:
generating an electronic waste report, wherein the electronic waste report includes the one or more electronic waste impacts; and
providing the electronic waste report to a user.
